(19) United States
(12) Patent Application Publication
(10) Pub. No.: US 2007/0189451 A1
(43) Pub. Date: Aug. 16, 2007

(54) Apparatus for inspecting a semiconductor device

(75) Inventors: Young-Soo Lee, Seongnam-si (KR); Dong-Chun Lee, Cheonan-si (KR); Seong-Chan Han, Cheonan-si (KR)

Correspondence Address: HARNESS, DICKEY & PIERCE, P.L.C., P.O. BOX 8910, RESTON, VA, 20195, US

(73) Assignee: Samsung Electronics Co. Ltd.

(21) Appl. No.: 11/703,249

(22) Filed: Feb. 7, 2007

(30) Foreign Application Priority Data
Feb. 10, 2006 (KR) 10-2006-0013138

(51) Int. Cl. G01N 23/06; G01F 1/66

(52) U.S. Cl. 378/51

(57) ABSTRACT

An apparatus for inspecting a semiconductor device may include an external image detector to acquire an exterior image of the semiconductor device, an internal image detector to acquire an interior image of the semiconductor device, and a controller to compare the acquired images with respective references. The apparatus may both inspect the exterior and the interior of the semiconductor device.

### PRIORITY CLAIM

A claim of priority is made under 35 U.S.C. §119 to Korean Patent Application No. 2006-13138, filed on Feb. 10, 2006, the entire contents of which are incorporated herein by reference.

### BACKGROUND

1. Field

Example embodiments may relate to an apparatus for inspecting a semiconductor device, for example, to an apparatus capable of simultaneously inspecting an exterior and an interior of a semiconductor device.

2. Description of the Related Art

With recent trends toward miniaturization and multifunction of electronic products, the number of electronic components mounted in and/or on a printed circuit board has increased. Accordingly, a printed circuit board may be formed of a multi-layered structure or may have wiring patterns of fine pitch.

Further, the size of electronic components has decreased. In some instances, critical faults may occur when a printed circuit board is fabricated or electronic components are mounted on a printed circuit board. Therefore, inspection of a semiconductor device may be an important manufacturing process.

Inspection of a semiconductor device may be implemented by an automatic optical inspector (AOI) and/or X-ray inspector. An AOI may irradiate light to a target and inspect the target with the image information obtained by the light reflected off the target. An X-ray inspector may irradiate X-rays to a target and inspect the target using image information obtained by measuring the transmitted X-rays. Typically, an AOI may be used to inspect an exterior of the target and an X-ray inspector may be used to inspect an interior of the target. The target may be a semiconductor device or a portion of the semiconductor device.

An X-ray inspector may be used to inspect solder joints in a ball grid array package, a chip scale package, and/or a flip chip bonding structure. An X-ray inspector may detect solder joint faults, for example, deformation, void generation, non-wetting, excessive solder, insufficient solder, and/or misalignment.

The electronics industry is increasingly using a ball grid array package and an embedded printed circuit board, in which a passive device may be mounted on a printed circuit board and/or in semiconductor device products, for example, semiconductor module products. Accordingly, the use of an AOI may be an increasing trend.

Currently, the exterior and interior of a semiconductor device are separately inspected using an AOI and an X-ray inspector, respectively, with separate inspection apparatuses. Separate inspection may be time consuming and inefficient.

### SUMMARY

Example embodiments may be directed to an apparatus for inspecting a semiconductor device that may simultaneously inspect the exterior and the interior of the semiconductor device.

In an example embodiment, an apparatus for inspecting a semiconductor device may include a loader load the semiconductor device onto the apparatus, an external image detector to acquire an exterior image of the semiconductor device, an internal image detector to acquire an interior image of the semiconductor device, a controller to inspect the acquired exterior and interior images, and to compare the images with respective reference images, a sorter to sort the semiconductor device according to the inspection result, an unloader to unload the semiconductor device from the apparatus, and a transfer unit to transfer the semiconductor device within the apparatus.

In another example embodiment, an apparatus for inspecting a semiconductor device may include an external image detector configured to acquire an exterior image of the semiconductor device, an internal image detector configured to acquire an interior image of the semiconductor device, and a controller to inspect the acquired exterior and interior images to determine whether the semiconductor device has any defects.

### BRIEF DESCRIPTION OF THE DRAWINGS

Example embodiments may be better understood with reference to the following detailed description thereof in conjunction with the accompanying drawings, wherein like reference numerals designate like structural elements.

FIG. 1 is a schematic view of an apparatus for inspecting a semiconductor device in accordance with an example embodiment.

FIG. 2 is an example schematic view of an external image detector of the apparatus of FIG. 1.

FIG. 3 is an example schematic view of an internal image detector of the apparatus of FIG. 1.

### DETAILED DESCRIPTION OF EXAMPLE EMBODIMENTS

Non-limiting example embodiments are described more fully hereinafter with reference to the accompanying drawings. However, the description should not be construed as limited to example embodiments set forth herein. Rather, the disclosed example embodiments are provided so that this disclosure will be thorough, and will fully convey the scope to those skilled in the art.

It should be noted that the figures are intended to illustrate the general characteristics of methods and devices of example embodiments. These drawings may not be to scale and may not precisely reflect all the characteristics of example embodiments, and should not be interpreted as defining or limiting the range of values or properties of the example embodiments. Rather, for simplicity and clarity of illustration, the dimensions of some of the elements are exaggerated relative to other elements.

Further, well-known structures and processes are not described or illustrated in detail to avoid obscuring example embodiments. Like reference numerals are used for like and corresponding parts of the various drawings.

It will be understood that when an element or layer is referred to as being “on”, “connected to” or “coupled to” another element or layer, it may be directly on, connected or coupled to the other element or layer or intervening elements or layers may be present. In contrast, when an element is referred to as being “directly on,” “directly connected to” or “directly coupled to” another element or layer, there may be no intervening elements or layers present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms may be only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting. As used herein, the singular forms “a”, “an” and “the” may be intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments may be described herein with reference to cross-section illustrations that may be schematic illustrations of idealized embodiments (and intermediate structures). As such, variations from the shapes of the illustrations as a result, for example, of manufacturing techniques and/or tolerances, are to be expected. Thus, the example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to limit the example embodiments.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

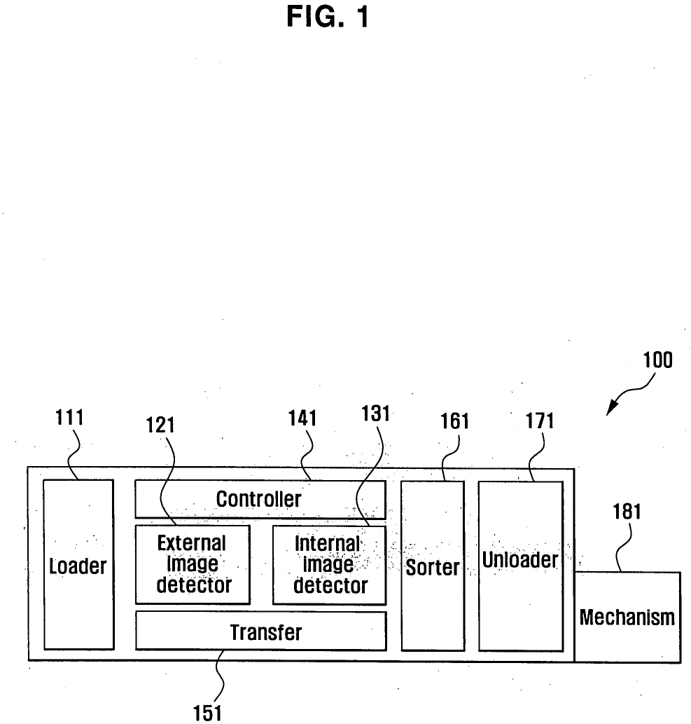

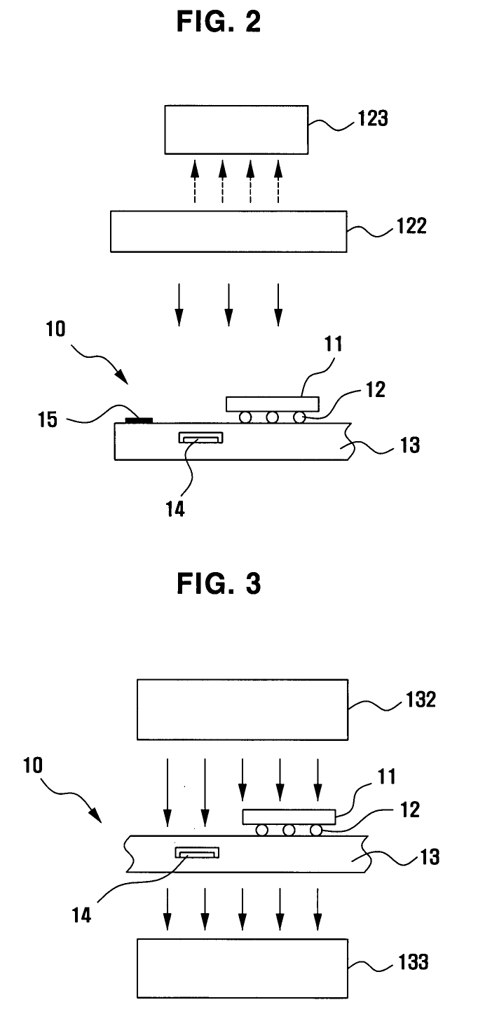

FIG. 1 is a schematic view of an apparatus 100 for inspecting a semiconductor device 10 in accordance with non-limiting example embodiments. FIG. 2 is a schematic view of an external image detector of the apparatus of FIG. 1. FIG. 3 is a schematic view of an internal image detector of the apparatus of FIG. 1.

Referring to FIGS. 1 through 3, the apparatus 100 may include a loader 111, an external image detector 121, an internal image detector 131, a controller 141, a sorter 161, an unloader 171, and/or a transfer unit 151.

The loader 111 may load a semiconductor device 10 (see FIG. 2) to the apparatus 100. The semiconductor device 10 may be a memory module. The loader 111 may have a load plate and a lift (not shown). The load plate may receive a container having the semiconductor device 10. The lift may vertically move the load plate. The semiconductor device 10 may be serially provided to each container.

The external image detector 121 may inspect the exterior of the semiconductor device 10. As shown in FIG. 2, the external image detector 121 may have a light source 122 and a camera 123. The light source 122 may emit light. The camera 123 may record an image reflected from the semiconductor device 10.

The semiconductor device 10 may include a semiconductor chip package 11 mounted on a printed circuit board 13 by solder balls 12. A passive device 14 may be disposed in the printed circuit board 13. The printing circuit board 13 may include an external structure 15 such as a tab terminal. The light source 122 of the external image detector 121 may irradiate light to an upper portion of the semiconductor device 10, and the camera 123 may record a reflected image. The external image detector 121 may capture an image of the exterior of the semiconductor device 10. The external image detector 121 may inspect the exterior of the semiconductor device 10 using the captured image.

The internal image detector 131 may inspect the interior of the semiconductor device with X-rays. As shown in FIG. 3, the internal image detector 131 may have an X-ray irradiator 132 and an X-ray detector 133.

The X-ray irradiator 132 may irradiate X-rays to the semiconductor device 10. The X-ray detector 133 may detect the transmitted X-rays to obtain a transmitted image of the interior of the semiconductor device 10. The internal image detector 131 may inspect the transmitted image of the passive device 14 disposed in the printed circuit board 13. For example, the internal image detector 131 may detect cracks in the passive device 14 and/or solder ball faults of the semiconductor package 11.

The external image detector 121 and the internal image detector 131 may be disposed serially in the apparatus 100. An external inspection and an internal inspection may be selectively performed in serial, or either of an external inspection and an internal inspection may be selectively performed.

In another example embodiment, the external image detector 121 and the internal image detector 131 may be disposed in parallel. An external inspection and an internal inspection may be selectively performed in serial, or either of an external inspection and an internal inspection may be selectively performed.

The internal image detector 131 may transmit X-rays to a portion, for example, a target area, of the semiconductor device 10 to obtained images of the desired portion. In another example embodiment, the internal image detector 131 may transmit X-rays to the entire semiconductor device 10, for example, the whole semiconductor device 10.

The controller 141 may compare the images obtained from the external image detector 121 and the internal image detector 131 to respective reference images to determine whether the semiconductor device 10 passes or fails the respective inspection tests. The controller 141 may be a computer and operated with software. The controller 141 may be configured to control the apparatus 100. Namely, the controller 141 may control after the inspection test, the sorter 161 to sort the semiconductor device 10. The sorter 161 may sort the semiconductor device 10 according to the inspection results.

After sorting the semiconductor device 10, the controller 141 may control the unloader 171 to unload the semiconductor device 10 from the sorter 161 unto a container in the unloader 171. Accordingly, the unloader 171 may be located near the sorter 161.

The apparatus 100 may further include a mechanism 181. The mechanism 181 may be configured to set the condition of the controller 141. The mechanism 181 may include an input unit, for example, a keyboard and/or mouse, and a display unit, for example, a monitor.

The transfer unit 151 may transfer the semiconductor device 10 within the apparatus 100. The transfer unit 151 may include a picker unit (not shown) using a vacuum adsorption method, a clamping unit (not shown) using a clamping method, a transfer rail (not shown), and/or a conveyor belt (not shown).

In accordance with example embodiments, an apparatus for inspecting a semiconductor device may both (for example, simultaneously) inspect the exterior and the interior of the semiconductor device, which may result in simple and efficient inspection of the semiconductor device. The apparatus may enable a reduced number of elements, thereby leading to reduced installation area, utilities, and/or human resources.

Although non-limiting example embodiments have been described in detail hereinabove, it should be understood that many variations and/or modifications of will still fall within the scope of the example embodiments.

What is claimed is:

1. An apparatus for inspecting a semiconductor device, the apparatus comprising:
a loader to load the semiconductor device onto the apparatus;
an external image detector to acquire an exterior image of the semiconductor device;
an internal image detector to acquire an interior image of the semiconductor device;
a controller to inspect the acquired exterior and interior images, and to compare the images with respective reference images;
a sorter to sort the semiconductor device according to the inspection result;
an unloader to unload the semiconductor device from the apparatus; and
a transfer unit to transfer the semiconductor device within the apparatus.

2. The apparatus of claim 1, wherein the external image detector and the internal image detector are provided in series.

3. The apparatus of claim 1, wherein the external image detector and the internal image detector are provided in parallel.

4. The apparatus of claim 1, wherein the external image detector includes a light source for emitting light and a camera for acquiring the exterior image of the semiconductor devices.

5. The apparatus of claim 1, wherein the exterior image is an image reflected from the semiconductor device.

6. The apparatus of claim 1, wherein the internal image detector includes an X-ray irradiator for irradiating X-rays to the semiconductor device, and an X-ray detector for detecting the transmitted X-ray image of the semiconductor device.

7. The apparatus of claim 6, wherein the X-ray irradiator irradiates X-rays to a target area on the semiconductor device.

8. The apparatus of claim 6, wherein the X-ray irradiator irradiates X-rays to the whole semiconductor device.

9. An apparatus for inspecting a semiconductor device, the apparatus comprising:
an external image detector to acquire an exterior image of the semiconductor device;
an internal image detector to acquire an interior image of the semiconductor device; and
a controller to inspect the acquired exterior and interior images to determine whether the semiconductor device has any defects.

10. The apparatus of claim 9, wherein the acquired exterior and interior images are compared with respective reference images to determine whether the semiconductor device has any defects.

11. The apparatus of claim 9, wherein the external image detector and the internal image detector are provided in series.

12. The apparatus of claim 9, wherein the external image detector and the internal image detector are provided in parallel.

13. The apparatus of claim 9, wherein the external image detector includes a light source for emitting light and a camera for acquiring the exterior image of the semiconductor devices.

14. The apparatus of claim 9, wherein the internal image detector includes an X-ray irradiator for irradiating X-rays to the semiconductor device and an X-ray detector for detecting the transmitted X-ray image of the semiconductor device.

15. The apparatus of claim 9, further including a sorter to sort the semiconductor device according to the inspection result.

16. The apparatus of claim 9, further including an unloader to unload the semiconductor device from the apparatus.

17. The apparatus of claim 9, further including a transfer unit to transfer the semiconductor device within the apparatus.
